(19) United States
(12) Patent Application Publication
(10) Pub. No.: US 2015/0026296 A1
(43) Pub. Date: Jan. 22, 2015

(54) INTERACTIVE GIFTWARE SYSTEM AND METHOD

(71) Applicant: Bernard B. HALPERN, Hallandale Beach, FL (US)

(72) Inventor: Bernard B. HALPERN, Hallandale Beach, FL (US)

(21) Appl. No.: 14/334,231

(22) Filed: Jul. 17, 2014

Related U.S. Application Data
(60) Provisional application No. 61/958,042, filed on Jul. 18, 2013.

(51) Int. Cl. H04L 29/08; H04B 5/00

(52) U.S. Cl. CPC H04L 67/06; H04B 5/00; G06Q 30/0601
USPC 709/217; 455/41.1

(57) ABSTRACT

An interactive giftware system, an interactive giftware item and method of retrieving content stored on server. The interactive giftware system includes a smart device, a server structured and arranged to store content, a giftware item having a notifier structured and arranged to establish a network connection with the smart device and to notify a recipient of the stored content, and an activation device located on the giftware item to authorize the content to play on the smart device.

### CROSS-REFERENCE TO RELATED APPLICATIONS

The present application is a U.S. Non-provisional Application claiming the benefit of U.S. Provisional Application No. 61/958,042 filed Jul. 18, 2013, the disclosure of which is expressly incorporated by reference herein in its entirety.

### BACKGROUND OF THE INVENTION

1. Field of the Invention

Embodiments of the invention are directed to an interactive giftware system that includes a giftware item.

2. Discussion of Background Information

Smart devices, including Apple and Android devices, such as smart phones, tablets and phablets are well known. These smart devices are equipped with suitable operating systems such as, e.g., iOS, Android, Windows Phone, BlackBerry, OSX, Linux, Windows 8, or other known operating systems and an Internet connection. Generally all of the smart devices currently available on the market are additionally equipped with Bluetooth technology, e.g., Bluetooth Smart 4.0 ultra low current drain, to establish a wireless connection with other Bluetooth enabled device.

Available in a growing number of smart devices are near field communication (NFC) devices, which allow the establishment of radio communication with another NFC enabled device via touching the devices together or bringing the devices into proximity with each other, i.e., generally no more than a few inches. Moreover, NFC enable device can establish communication with an unpowered NFC chip, sometimes referred to as a “tag.” While Apple devices are not currently equipped with NFC capability, it is rumored that future generations of Apple devices will include NFC technology.

Gift-giving between friends and loved ones is a timeless expression of affection and caring. In addition to shopping for a present, the gift giver may also search for an appropriate card to encapsulate their feelings for the recipient, whether humorous, emotional, sympathetic, supportive, to accompany the present. However, even the “perfect” card is not an adequate substitute for seeing the giver offer his/her own words to the recipient.

Video/audio messaging applications running on smart devices are likewise well known to enable family and friends to send personalized audio and video messages to loved ones through the Internet. An individual can record and save a video message with a known recording application stored on the smart device and then share the video message with a desired recipient via email of a known social media application, such as Facebook, Snapchat, Vine, Instagram etc. In this way, the recipient receives a notification on their smart device informing them that a message has been sent to them, and then opens the relevant application to retrieve and view the video message. The notification can be specified ringtones, vibrations and/or lights on their smart phone.

### SUMMARY OF THE EMBODIMENTS

Embodiments of the invention are directed to interactive giftware that allows the recipient to be notified of incoming content, e.g., audiovisual content, such as video and/or audio messages, photos, etc., authored/uploaded by the giver. A non-limiting example of such an interactive giftware system within the scope of the pending application and claims is Applicant's “Popqode.”

In embodiments, giftware products or items can include specific electronic components that are embedded within or affixed upon the giftware items. In particular, the giftware items can incorporate an affixed or embedded NFC (Near Field Communication) device or tag, which can be with or without a ferrite backing, and/or a QR code image of any color or colors affixed, imprinted, embedded, or engraved in or on the giftware items and/or a Bluetooth device provided with or without a tactile sensor or switch embedded in the giftware items.

In embodiments, a giftware item can be structured to notify a recipient of new incoming content with lights, sounds and/or vibrations.

In other embodiments, the giver's video messages can be retrieved and played on the recipient's smart device when the recipient performs a simple act. The simple act can be, e.g., to position the smart device in a close proximity to a specified location on the giftware, to capture a QR code imprinted or affixed on the giftware or to touch a button or specified location on the giftware.

In embodiments, the content can begin playing automatically on the recipient's smart device upon the completion of the simple act, thereby avoiding a need to open an application on the smart device or to pull down screen menus before playing the retrieved content.

In still other embodiments, the video messages can be received and played on the recipient's smart device even without the recipient touching their smart device.

Further, a smart device using a notification can allow recipient to program the notifier of the giftware item via a bluetooth wireless signal. A programmable chip or chips of the notifier can control the lighting of the LEDs, the vibration of the vibrator and the sound emitted from the speaker (miniature sound transducer).

Embodiments of the invention are directed to an interactive giftware system that includes a smart device, a server structured and arranged to store content, a giftware item having a notifier structured and arranged to establish a network connection with the smart device and to notify a recipient of the stored content, and an activation device located on the giftware item to authorize the content to play on the smart device.

According to embodiments, the notifier may include the activation device.

In accordance with other embodiments of the invention, the activation device can include a near field communication (NFC) device.

In still other embodiments, the activation device can include at least one of a tactile sensor and an accelerometer. Further, the tactile sensor may include a push button switch and/or may include a proximity switch.

According to embodiments, the activation device can include a quick response (QR) code.

In accordance with further embodiments of the instant invention, the notifier may include an NFC device and a Bluetooth component.

Moreover, the notifier may include an NFC device and a Bluetooth component and the giftware item includes a QR code.

In other embodiments, the notifier can include at least one of: at least one light emitting diode (LED); a sound transducer; and a vibration device.

According to still other embodiments, the giftware item can include at least one of: jewelry with at least one of precious, semiprecious, synthetic and/or resin stones; jewelry without stones; clothing items; stuffed toys; and drinking vessels.

In accordance with other embodiments, the smart device can include at least one of a smart phone, tablet or phablet.

Still further, the giftware item may include a unique identifier designating a location in the server for the content uploaded for the giftware item.

Embodiments of the instant invention are directed to an interactive giftware item that includes a notifier having at least one of: an NFC device; and a Bluetooth module and at least one of a tactile sensor and an accelerometer, at least one of: at least one light emitting diode (LED); a sound transducer; and a vibration device, and a controller structured and arranged to control the notifier.

According to embodiments, the giftware item can include at least one of: jewelry with at least one of precious, semiprecious, synthetic and/or resin stones; jewelry without stones; clothing items; stuffed toys; and drinking vessels.

In accordance with other embodiments, the tactile sensor may include at least one of a push button switch and a proximity switch.

In further embodiments, the interactive giftware item can include a QR code at least one of affixed to and imbedded on the giftware time.

Embodiments of the invention are directed to a method for retrieving content stored on a server. The method includes receiving a notification from a giftware item of new content uploaded to a server and activating the giftware item, which instructs a smart device to retrieve and play the content.

According to other embodiments, the smart device can include a notification application to communicate with the server and the giftware item.

In accordance with still yet other embodiments of the present invention, the smart device can retrieve and play content stored in a location in the server designated by a unique identifier of the giftware item.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 illustrates an exemplary embodiment of an interactive giftware system;

FIG. 2 illustrates an exemplary embodiment of a notifier of an interactive giftware item;

FIG. 3 is an exemplary flow diagram of the gift giver's actions in activating the giftware item;

FIG. 4 is an exemplary flow diagram of the server's actions in activating the giftware item; and

FIG. 5 is an exemplary flow diagram of the gift recipient's actions in activating the giftware item.

### DETAILED DESCRIPTION OF THE EMBODIMENTS

The particulars herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

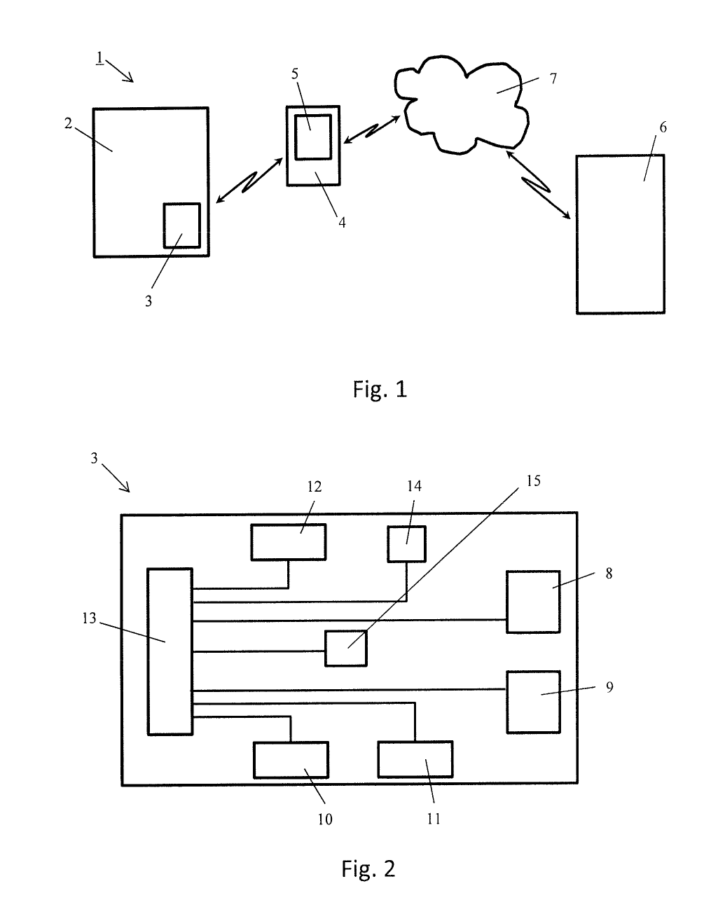

FIG. 1 illustrates an interactive giftware system 1 that allows the recipient to be notified of new content, e.g., audiovisual content, such as video and/or audio messages, photos, etc., authored/uploaded by the giver intended for the enjoyment of the recipient. A giftware item 2, e.g., jewelry with or without precious, semiprecious, synthetic and/or resin stones, such as pendants, cabochon pendants, bracelets, rings and watches; clothing items, such as shirts, caps and jackets; stuffed toys, such as stuffed animals or dolls; drinking vessels, such as mugs and water bottles; and frames, may include a notifier 3 that can be incorporated into or fixedly attached to giftware item 2. A smart device 4, e.g., a smart phone, tablet, phablet, etc., running an application 5 associated with interactive giftware system 1 can establish a local, personal network with giftware item 2 and a virtual wireless connection with a server 6 via a network 7, such as the Internet, a public or private network, a local area network, WiFi, WiMax, other known networks and combinations thereof.

Smart device 4 can include an operating system, e.g., iOS, Android, Windows Phone, BlackBerry, OSX, Linux, Windows 8, or other known operating systems, stored in an internal memory so that smart device 4 will operate in its intended manner. Further. smart device 4 can include a radio transmitter and receiver connectable to a network 7, and associated software and/or firmware to transmit and receive data to/from server 6 via TCP/IP or other suitable protocol. In the illustrated embodiment, smart device 4 can be the gift recipient's device. Further, smart device 4 can include a Bluetooth component to establish the local, personal network to communicate with a remote Bluetooth compatible device. Additionally or alternatively, smart device 4 can also include a near field communications (NFC) device or chip that can establish another local, personal network to communicate with a remote NFC device in a remote device, e.g., by moving the NFC chip into close proximity to another NFC device or vice versa. Smart device 4 can be equipped with a known application to read and decode a character string embodied or formed as a machine-readable code, such as barcodes or quick response (QR) codes. Further, smart device 4 can include an application 5 associated with receipt of giftware item 2 in order to access content sent to the recipient by the gift giver. Application 5 can include a program to send a notification signal to giftware item 2 in response to a notification received by smart device 4 from server 6 of new content having been uploaded for the recipient of giftware item 2. Moreover, application 5 can also include an application to read and decode a character string embodied or formed as a machine-readable code, such as barcodes or quick response (QR) codes.

Server 6 can include one or more memory devices accessible by the recipient through the application 5 running on smart device 4. Further, the gift giver can download application 5 onto his/her own smart device so that content stored on the giver's smart device, e.g., video files, photos, audio files, audiovisual files, or other content to be shared by the giver, can be uploaded to server 6 for the benefit of the recipient. When content is uploaded by the giver to server 6, server 6 determines the intended destination of the content and transmits a notification to application 5 that content from the giver is waiting for retrieval. Application 5 then instructs notifier 3 to notify the recipient of the waiting content from the giver. The recipient can then retrieve and play the content on smart device 4.

FIG. 2 illustrates in greater detail notifier 3 of giftware item 2. Notifier 3 can include a Bluetooth component 8, e.g., Bluetooth low energy (LE)/Bluetooth Smart or Bluetooth 4.0, so that giftware item 2 is Bluetooth ready and compatible. Additionally or alternatively, notifier 3 can include an NFC device 9, either an active chip powered by a battery or a passive element or “tag.” Further, if an NFC tag is to be used on a metallic surface, it may be advantageous to include a ferrite backing to substantially prevent the metallic surface from interfering with the tag's antenna range and its induction capabilities. Moreover, notifier 3 can include devices to alert the gift recipient of incoming messages By way of non-limiting example, one or more light emitting diodes (LEDs) 10 to emit an optical notification, a sound transducer 11 to emit an audible notification and/or a vibrator 12 to emit a physical notification. A controller 13, which can be a programmable processor, is connected to Bluetooth component 8, NFC chip 9, LEDs 10, sound transducer 11 and vibrator 12. Controller 13 can be programmed so that a specified notification of lights, sound and/or vibration is output by notifier 3 upon receiving via Bluetooth component 8 a notification of new content available for the recipient. A memory 14 can store instructions or commands for projecting the notification for giftware item 2. For example, memory 14 can store programmed or predetermined notification for illuminating one or more colors and/or patterns for LEDs 10, store a predetermined notification audio file for replay through sound transducer 11, and/or a predetermined notification vibration pattern for vibrator 14. Additionally or alternatively, another programmable processor (not shown), e.g., with an incorporated sound amplifier, can be associated with sound transducer 11, which can include a miniature speaker. Such a processor may include it own memory for storing audio files for retrieval and playback when activated by controller 13. Moreover, a notifier 3 can also include a power supply, such as a battery, to supply power to the various elements of notifier 3.

In operation, application 5 can instruct, via Bluetooth device 8, controller 13 to turn on LEDs 10 in a predetermined manner set by the application or the recipient, e.g., to glow or blink in same or different colors and/or patterns, to emit a predetermined sound, e.g., a ringtone, and/or to enable the vibrator to vibrate in a predetermined manner, e.g., constant or pulsing. Notifier 3 can also include a tactile sensor 14, e.g., a mechanical switch, a depressable key switch, a non-depressable contact switch using, e.g., piezoresistive, piezoelectric, capacitive and elastoresistive sensors, or a non-contact, proximity switch using, e.g., capacitive sensors. Giftware item 2 can also include a unique character string embodied or formed as a machine-readable code, e.g., a bar code or QR code, which identifies the specific giftware item 2. This unique character string can be affixed, imprinted, embedded, or engraved on giftware item 2.

Once a notification is realized on giftware item 2, the recipient can access the content stored in server 6 as a result of a number of simple acts. By way of non-limiting example, the recipient can move his/her smart device 4 to tap or to simply be in close proximity to NFC device 9, whereby the application understands this action as an instruction to instantly begin receiving the content, e.g., streaming from server 6 and played on smart device 4. In another non-limiting example, the recipient can use a code reader, e.g., QR code reader, in application 5 to read the code imprinted on or affixed in some manner to giftware item 2 to decode the QR code, whereby the application understands this action as an instruction to instantly begin receiving the content, e.g., streaming from server 6 and played on smart device 4. When application 5 sends the notification to controller 13 of notifier 3, application 5 can then open the code reader on smart device 4 so that no action or manipulation of pull-down menus is required by on the part of recipient. In still another non-limiting example, the recipient can touch or depress tactile sensor 14, which can be located on giftware item 2, e.g., as part of notifier 3. Tactile sensor 14 can be arranged to instruct controller 13 to authorize, via Bluetooth device 8, application 5 to instantly begin receiving the content, e.g., streaming from server 6 and played on smart device 4. In still other embodiments, an accelerometer 15 can be attached to giftware 2, e.g., as part of notifier 2, and connected to controller 13 to monitor a shaking or agitation of giftware item 2 as a manner of authorizing the downloading and playing of content on smart device 4. For example, when the giftware item 2 notifies the recipient of the waiting new content, the recipient can shake giftware item 2, whereby accelerometer 15 can sense the shaking and, thereby, can instruct controller 13 to authorize, via Bluetooth device 8, application 5 to instantly begin receiving the content, e.g., streaming from server 6 and played on smart device 4.

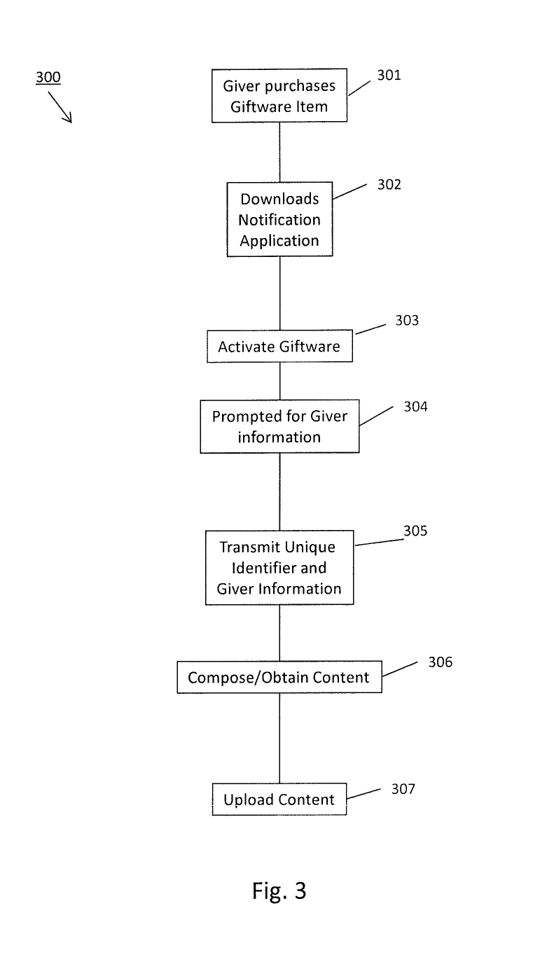

FIG. 3 illustrates a flow diagram of an exemplary process 300 performed by the gift giver for setting up the initializing giftware item 2 within interactive giftware system 1. At 301, the gift giver purchases giftware item 2. After purchasing, the giver is instructed to activate giftware item 2 so that the recipient can receive the giver's composed content upon receipt and recipient's activation of giftware item 2. In particular, at 302, the giver is instructed to download notification application 5 onto the giver's smart device and to run an initialization procedure or routine. At 303, the giver is instructed to activate giftware item 2, which can be done by decoding a character string, such as a bar code or QR code, with a camera/decoder in application 5 to reveal a unique identifier for giftware item 2 and to input this unique identifier into application 5; or which can be done by tapping the giver's smart device to an identified area of giftware item 2 (or placing the giver's smart device in close proximity to the identified area of giftware item 2) whereby the unique identifier for giftware item 2 is transmitted to application 5 from controller 13 via the NFC device pairing between the giver's smart device and giftware item 2; or which can be done by touching or depressing tactile sensor 14, whereby the unique identifier for giftware item 2 is transmitted to application 5 from controller 13 via Bluetooth device 8. At 304, the giver can be prompted to input giver information, such as a user name and password for use in uploading future content for the recipient through giftware item 2. At 305, the initialization of giftware item 2 is complete and the unique identifier for giftware item 2 and the giver's information is transmitted to server 6. The giver can then compose and store content specifically intended for the recipient on the giver's smart device at 306. However, it is not necessary that the giver compose new content, as non-unique content and/or content previously stored on or obtained on the giver's smart device can also be uploaded for the benefit of the recipient. At 307, the giver can then upload, via application 5, desired content intended for the recipient that is stored on giver's smart device.

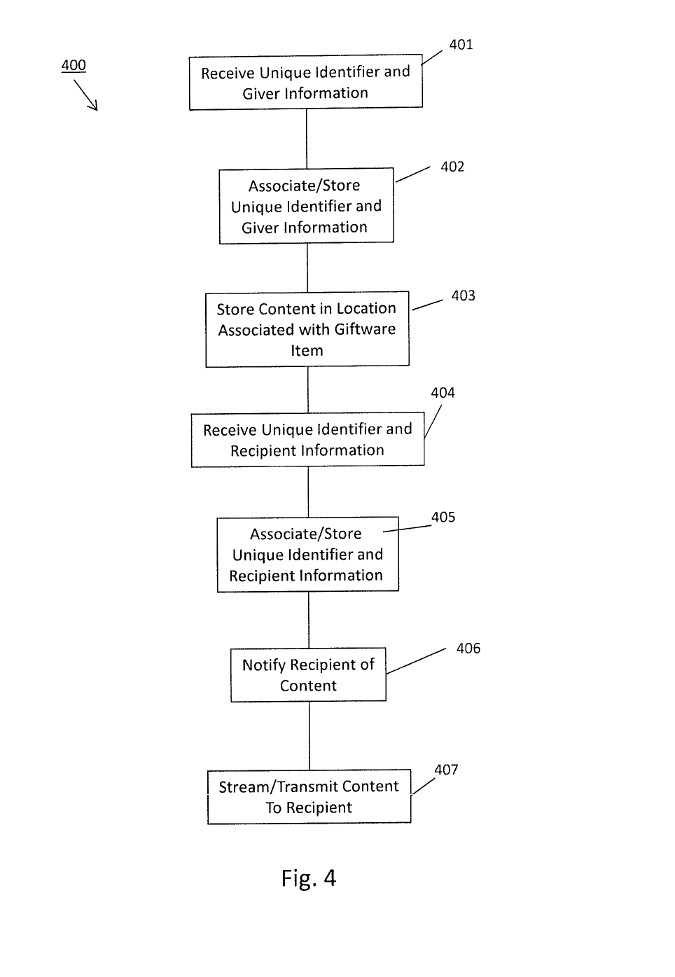

FIG. 4 illustrates a flow diagram of an exemplary process 400 performed by the server to initialize giftware item 2 within interactive giftware system 1. At 401, server 6 receives the giver's information and the unique identifier of giftware item 2. The server 6, at 402, associates and stores the giver's information with the unique identifier, which is already stored in server 6. At 403, server 6 receives the content uploaded by the giver, and associates and stores the content with the giftware item 2. However, as server 6 has not yet received recipient information for this giftware item 2, a notification cannot yet be sent. Accordingly, server 6 awaits receipt of the recipient information for this giftware item 2 before transmitting a notification to the recipient regarding the waiting content. At 404, server 6 receives the recipient's information and the unique identifier of giftware item 2. The server 6, at 405, associates and stores the recipient's information with the unique identifier, whereby the giver and recipient information is now associated with giftware item 2. At 406, server 6 notifies the recipient of the content uploaded by the giver. At 407, server 6 receives authorization from application 5 on the recipient's smart device 4 to stream or download the content to smart device 4.

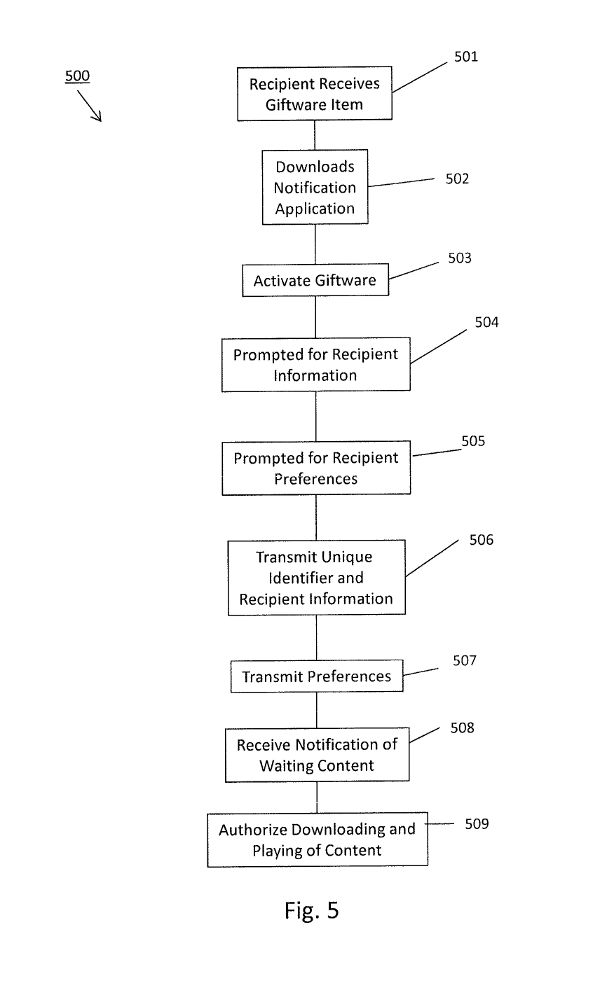

FIG. 5 illustrates a flow diagram of an exemplary process 500 performed by the gift recipient for completing the initialization of giftware item 2 within interactive giftware system 1. At 501, the recipient receives giftware item 2 from the giver. After receipt, the recipient is instructed to activate giftware item 2 so that notification of the giver's uploaded content can upon activated on giftware item 2. In particular, at 502, the recipient is instructed to download notification application 5 onto smart device 4 and to run the initialization procedure or routine. At 503, the recipient is instructed to activate giftware item 2, which can be done by decoding the character string, such as a bar code or QR code, with the camera/decoder in application 5 to reveal the unique identifier for giftware item 2 and to input this unique identifier into application 5; or which can be done by tapping the recipient's smart device to an identified area of giftware item 2 (or placing the giver's smart device in close proximity to the identified area of giftware item 2) whereby the unique identifier for giftware item 2 is transmitted to application 5 from controller 13 via the NFC device pairing between the giver's smart device and giftware item 2; or which can be done by touching or depressing tactile sensor 14, whereby the unique identifier for giftware item 2 is transmitted to application 5 from controller 13 via Bluetooth device 8. At 504, the recipient can be prompted to input recipient information, such as a user name and password for use in retrieving content stored in server 6 associated with giftware item 2. In addition to this basic information, the recipient can be prompted to supply preferences in application 5, e.g., related to a specified notification, i.e., the manner in which lights, sounds, and vibrations on giftware item 2 will be or will not be utilized when the recipient is notified of waiting content from the giver at 505. At 506, the initialization of giftware item 2 is completed and the unique identifier for giftware item 2 and the recipient's information is transmitted to server 6. Further, at 507, the preferences can be transmitted to notifier 3 to program the desired notification into controller 13 via Bluetooth device 8. At 508, the recipient can then receive, via notifier 3, a notification from server 6 of the giver's waiting content, and at 509, the recipient can authorize, by activating giftware device 2, downloading and playing of the giver's content on smart device 4.

Many different types of giftware items can be incorporated into interactive giftware system 1. For example, when giftware item 2 is formed of glass or stone, tactile sensor 14 can be advantageously embodied with a sensor or chip to generate a capacitive field so that activation can be achieved through a gentle touch. By way of non-limiting example, when giftware item 2 is a cabochon pendant the Bluetooth module and a capacitive proximity switch or tactile sensor can be arranged under or within the stone and/or upon the tray that the stone is set in. In this manner, touching the stone with a finger is sufficient to authorize the retrieval and playing of the content. Still further, a vibrator can be incorporated with the pendant in order to give haptic feedback when the product is touched. Further, a battery compartment can be provide on the back of the cabochon pendant, and can be accessible through a screw type lid, e.g., as in conventional wristwatch case backs.

In conjunction with the giftware described above, it is preferable to have a smart device equipped with both an NFC radio and Bluetooth radio. The associated downloaded application 5 may or may not be preferred, depending on the interactive features desired. It may also be preferred that smart device 4 has a live internet connection via either WiFi, wireless broadband or any other type of available network connection. It may also be preferred that the Bluetooth radio of smart device 4 be on and be paired to the Bluetooth component 8 of notifier 3.

In the foregoing discussion, the content uploaded by the giver can begin to play on the recipient's smart device as soon as one of the above-noted simple acts is completed. However, embodiments of the invention contemplate the receiver receiving content from the host of the interactive giftware system via the server. Such content can be obtained on a subscription basis obtained through application 5, on a cost per download basis, as a complimentary service from the host, on other cost bases, or combinations thereof. The content from the host can be automatically uploaded to server 6, e.g., on a daily, weekly, monthly basis, so that the content is regularly updated for the enjoyment of the recipient. By way of non-limiting example, the content from the host can be available for downloading at preset times, and the content can be, e.g., daily horoscopes, daily inspirational messages, jokes of the day; words of the day, etc. As the content is uploaded at a same time, a notification to the recipient may not be necessary. That is, after the daily upload time, rather than the server notifying the recipient of the new host content, the recipient can log into application 5 or an official website of the host to change preferences in order to control/request host content to be received, e.g., by selecting content in categories such as health, love, money, etc. In further embodiments, while the host content may be uploaded, e.g., at 12:01 am daily, the user may not want to receive a notification of such content until later in the day. Accordingly, it is further contemplated for the recipient to log into application 5 or an official website of the host to set a preference for receiving notifications of host content at, e.g., 9:30 am daily and set a second predetermined notification, distinct from the notification for content from the giver, to inform the recipient of the new host content available on server 6.

In other embodiments, notifier 3 of giftware item 2 may only include an affixed or imbedded NFC device 11. In the above-described embodiment in which host content is uploaded at a same time on a regular basis, a notification to the recipient may not be necessary. Instead, at any time after the preset upload time for the host content, the recipient can tap the affixed or imbedded NFC device with his/her smart device 4 to begin immediate playing of the host content on smart device 4. In this case, the recipient can be notified of the preset times for uploading host content when setting up their application 5 to receive, e.g., content daily, such as a daily horoscope.

In still other embodiments, notifier 3 of giftware item 2 may only include an affixed or engraved QR code. In such embodiments, in order for the desired effect of the content to begin playing immediately after the recipient scans the QR code image with smart device 4. In this scenario, as there are a number of QR code reader applications available, it may not be necessary for the recipient to use the QR code reader in notification application 5. However, by way of further non-limiting example, the server can be set up in such a manner that, if a non-registered person attempts to receive the content using a third party QR code reader application, server 6 can return, in lieu of the requested content, a splash page instructing them to download notification application 5 and to register a user name and password in order to re-scan the QR code and to see the content only once or not at all. In this manner, privacy of the content intended for the recipient can be protected.

In further embodiments, notifier 3 of giftware item 2 may only include Bluetooth device 8 and tactile sensor 14. In such embodiments, by touching tactile sensor 14, e.g., a tactile switch or capacitive switch, the desired effect of immediately playing the uploaded content on smart device 4. Further, it is contemplated that the giftware items 2 in accordance with any of the described embodiments can include more than one tactile sensor 14 so that different content is accessible by touching different tactile sensors.

As the recipient's smart device 4 already includes a Bluetooth device, it may not be desired by the recipient to download application 5 in order to pair smart device 4 with giftware item 2. In view of the above-discussion, it may be particularly advantageous when Bluetooth device 8 is provided in combination with tactile sensor 14. It may also be advantageous when these elements are combined with a battery so that smart device 4 can be awoken from a screen sleep mode and begin playing the uploaded content automatically. In contrast, in the above-described embodiments in which notifier 3 includes only a QR code or only an NFC device, it may be preferable that the screen of smart device 4 to be on and extra steps are taken before content is downloaded and played, e.g., physically tapping the designated area on a product where the NFC tag is embedded, or in the case of a QR code image, opening a QR code reader application before reading and decoding the QR code.

In the preceding and following examples, giftware item 2 can include one, a plurality of or all of the hardware components described above in order to achieve a desired interactive effect, e.g., so that the recipient will see lights (LEDs), hear sound (speaker/sound transducer), and/or feel something (vibrator) as an indication that content has been uploaded to server 6.

The notification is prompted by the giver having designated giftware item 2 as recipient of the uploaded the content to server 6. Further, the content uploaded to server 6 can be saved in the format in which the content was originally generated and saved to a file location associated with the unique identifier of the giftware item 2.

As discussed above, each giftware item 2 has a unique identifier assigned to it. Server 6 allocates hard drive or solid state memory for each received URL or short URL, which is randomly generated by third party services, such as Google. Moreover, for each received randomly generated URL or short URL, an associated alphanumeric identifier, which may be typically 12 to 16 characters in length, is generated. The URLs and their associated alphanumeric identifiers are downloaded by an administrator of a company, e.g., the host, in any quantity, and are associated with a respective giftware item 2 as its unique identifier.

For QR code generation, server 6 can generate a QR code with matching graphics for each URL and its associated alphanumeric identifier. The parameters of the graphical images of generated QR codes can vary in size, file type, nesting and templating configuration, and resolution, and other graphical enhancements such as contrasting colors and backdrop imagery as the administrator has designated, for later imprinting or engraving on respective giftware items 2.

For NFC tags, typically an Excel file with any requested number of generated URLs and associated alphanumeric identifiers is downloaded to a computer connected to an NFC device writer, where each NFC device is written with a URL and an associated alphanumeric identifier. NFC device can be made “read only” with encoding techniques during the writing process. Moreover, this can be done in volume via NFC devices on a roll with a reel to reel NFC device writing machine.

For Bluetooth components, typically an Excel file with any requested number of generated URLs and associated alphanumeric identifiers is downloaded to a computer connected to a Bluetooth equipped radio that transmits the URLs and associated alphanumeric identifier to each Bluetooth component. The Bluetooth component can be made “read only” with encoding techniques during the writing process.

The 12 to 16 digit alphanumeric identifier can be used as an activation code when the giver and recipient register and activate the giftware item 2 when first tapping it with a smart phone (reading the embedded NFC tag), or tapping or touching it with a finger, or scanning it with the QR scanner feature of application 5.

Once giftware item 2 is activated, it is ready to receive content uploaded by the giver or to receive host content. In the case of interactive giftware items, when application 5 is opened, the giver is prompted to take a video with sound using their smart device camera and microphone, and then to upload this content to the recipient. In the event the giver has given giftware items to more than one recipient, as the giver activates each giftware item, a recipient list is generated so that the giver can different selected content to some or all of the recipients in the generated list. Further, for the recipient, all that is needed is to download application 5 onto smart device 4, activate giftware item 2 and to register an account. It can also be possible for users to refuse notifications until permission is given in the preferences in application 5 to receive messages uploaded to their giftware item 2.

In a non-limiting example of the interactive giftware system according to embodiments, a mother of 3 children can purchase a coffee mug, e.g., as a Fathers Day gift for her dad who lives in a different city. She can download the notification application mobile app for her smart device equipped with an NFC device and tap the mug on the spot where the NFC device is embedded (for example on our imprinted logo). The NFC device can be encoded with a URL pointing to a designated memory location on the server. Within the application, she can take a video with her smart device of the children playing with their new puppy, after which she can send it to her father or any other recipient of an interactive giftware item listed within her list of recipients.

Far away, after receiving the gift mug, her father can be sipping his morning coffee when the same mug he is drinking from may begin to glow and/or flash, and/or vibrate, and/or make any sounds such as play a song or a snippet of his daughters voice. This is a notification that his daughter has “popped” a video/audio message for him to enjoy through his mug. The father can then tap his NFC enabled smart device to the logo (with the hidden NFC device beneath it) to begin viewing the movie she just created moments beforehand.

If the gift mug has been equipped with only an affixed NFC device with no other electronic components, the father can simply tap the mug from time to time, e.g., each morning, to see if any new content was “popped” to it, or he may receive a notification via the notification application on his smart device that his daughter sent him an audio visual message which would then be his cue to tap his mug to see and hear the content play.

In the above example, it is within the scope of the invention that the giftware item is an interactive product in which audio visual content can be retrieved with or without notification. The giftware item can be an integral part of the receiving end of the messaging process and experience.

In another non-limiting example of the interactive giftware system according to embodiments, a person who lost a loved one who has made a memorial video slide show may wish to purchase a sterling silver cabochon semi-precious or precious stone pendant. The pendant may have a ferrite backed NFC device inserted and hidden beneath the stone on the surface of sterling silver tray or any other metal tray, which has been encoded (as explained above) for activation. When the person activates their pendant, they can then upload their existing memorial video/slideshow to the server. Now they have the comforting knowledge that the life and times of the person who passed is seemingly encapsulated within that stone, and whenever that person wants to hear and see the imagery and sounds of their loved one who has passed, all they need to do is tap the stone with their NFC equipped smart device. Because of possible metallic deposits in some semi-precious stones such as Labradorite or Rutilated Quartz, which may interfere with the induction capability of the embedded NFC device, the NFC device may be installed on the back of the cabochon pendant, with or without covering of any non-metallic type of material such as opaque glass, ceramic, or ceramic resin material, or resin (plastic), etc., that would not interfere with the reading of the embedded NFC device with an NFC equipped smart device. On the back of the pendant, there may be an incorporated vessel designed to hold a small amount of ashes or hair of the deceased person, where the video audio content is that of the person whose very ashes or hair is stored within the same pendant.

In still another non-limiting example of the interactive giftware system according to embodiments, a person who enjoys reading their daily Horoscope or receiving daily affirmations may wish to purchase a sterling silver cabochon semi-precious stone pendant with a 12 month subscription for streaming content served up daily at 12:01 am by the server. The pendant can have a Bluetooth module with a tactile sensor and a battery hidden beneath the cabochon stone, i.e., between or within the stone and the surface of the sterling silver or any other metal tray, which has been encoded (as explained above) for activation. The stone may move slightly via a spring loaded action of the embedded tactile switch or a separate hidden spring when depressed. After the person has activated their pendant, they can then login at anytime and set certain content parameters such as receiving their daily horoscope, the “quote of the day”, or daily inspirational messages at set times. Now they have the ability to simply touch the stone gently with their finger to cause the embedded tactile switch to be depressed, thereby causing the embedded Bluetooth radio module to send a signal to the wearer's smart device to the turn its screen on and access the encoded URL to begin streaming the content from the server. The smart device screen can come to life and begin playing the desired content that have subscribed to.

In a further non-limiting example of the interactive giftware system according to embodiments, best friends can purchase matching rubber bracelets, which can be sold in pairs. The friends can register accounts and activate the NFC devices in the bracelets. Each friend then becomes the recipient of the other friend's frequent “pops” of spontaneous videos, pictures, etc. In this example, The cost may be kept down where the rubber bracelet includes only an encoded NFC device without a notifier. However, a more expensive version of a bracelet is also contemplated, which includes an embedded notifier.

In a still other non-limiting example of the interactive giftware system according to embodiments, when purchasing a giftware item, a limited time subscription, e.g., a 12 month subscription, can be offered by the host or can be purchased by the giver when activating the giftware item for dynamic streaming content. For purchased content, payment can be made with a credit card, which can, e.g., be kept be on file. Further, the purchased subscription can be auto-renewed at the end of the subscription period, e.g., for another 12 months, at a designated rate, or the user can log into the application and cancel it.

In another non-limiting example of the interactive giftware system according to embodiments, the host can purchases licensing from individuals, e.g., celebrities such as ball players, teen idols, actors, recording artists, etc. Through the use of giftware items, e.g., inexpensive silicone rubber bracelets or inexpensive costume jewelry with resin cabochon stones on base metal trays as pendants, bracelets or rings, baseball caps, etc., with a notifier. The jewelry or clothing item may have the celebrity's famous name or image integrated within or upon the item and may also incorporate a QR code image. Contractual agreements can be obtained from famous personalities, who agree to record and post photos and/or short videos and upload them at an agreed to period, e.g., daily, to their faithful fans, who have purchased the licensed giftware.

Because storage space is not unlimited, it is within the scope of the disclosed embodiments to control the length of time that content can be stored on the server or to limit the number of times the content can be viewed. As content uploaded by the giver is saved in a location in server 6 associated with the unique identifier of giftware item 2, it may be advantageous that previously viewed content is automatically deleted from server 6 after a predetermined period of time, e.g., 24 hours, one week, until new content is uploaded, etc., or after a predetermined number of views, e.g., 1 time, 5 times, unlimited until new content uploaded, etc. Moreover, if the giver attempts to upload new content before previously uploaded content has been viewed, server 6 can return a message via application 5 that the content is already stored and can request an instruction whether the older content from the giver should be overwritten with the new content or whether the older content should remain until viewed or time for viewing has expired. Alternatively, server 6 can return a message via application 5 informing the giver that no new content can be stored at this time and to try uploading the new content later. Still further, it is contemplated that server 6 can store the content until new content is uploaded.

As the content can sometime stir strong emotions in the viewer/recipient, the recipient may want the option to save certain viewed content received from the giver. By way of non-limiting example, the recipient can obtain/purchase storage space in a remote server under the control of the host or via a third party, e.g., in the “cloud,” to archive the content for future viewing and enjoyment. By way of further non-limiting example, after the content is viewed, application 5 can inquire as to whether the recipient would like the just viewed content to be saved for future viewing. If answered in the affirmative, application 5 may request instructions as to where to save the content, e.g., on an SD card in the smart device, on a remote server, etc., and then perform the instructed task. After storing, application 5 can request instructions to delete the content on server 6 or the content can be automatically deleted once it has been archived elsewhere. If the recipient opts not to archive/save the content after viewing, application 5 can inform the recipient of the status of the content on server 6, e.g., how much longer the content will be stored, how many more time the content can be viewed. Of course, the recipient could also be informed of the status of the content on server 6 before inquiring whether to save the content.

In addition to limiting storage space, it may also be advantageous to restrict or limit the duration of the content uploaded to server 6 to, e.g., 7 seconds, 10 seconds, 30 seconds, etc.

Of course, when content is a memorial video slide show or other content that is not intended to be updated or replaced with new content, application 5 can include within the recipients' preferences a designation that the content be saved as a memorial so that new content will not replace the memorial content stored in server 6 without the recipient's permission. This would allow the purchaser of memorial giftware to avoid having to purchase remote server storage space and enable him/her to remember their loved by viewing the memorial content on server 6 in an unlimited manner. Further, when giftware item 2 is a piece of jewelry intended as a memorial for a dearly departed family member or friend, server 6 can recognize from the unique identifier that the uploaded content is to be saved as memorial content for unlimited viewing.

Although the embodiments of the invention have been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Further, it is understood that features of the various embodiments can be combined without departing from the spirit and scope of the invention.

In accordance with various embodiments of the present invention, the methods described herein can be implementable for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that software implementations of the embodiments of the present invention may be optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to e-mail or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Accordingly, replacement standards and protocols having the same functions are considered equivalents.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. An interactive giftware system comprising:
a smart device;
a server structured and arranged to store content;
a giftware item having a notifier structured and arranged to establish a network connection with the smart device and to notify a recipient of the stored content; and
an activation device located on the giftware item to authorize the content to play on the smart device.

2. The interactive giftware system according to claim 1, wherein the notifier comprises the activation device.

3. The interactive giftware system according to claim 1, wherein the activation device comprises a near field communication (NFC) device.

4. The interactive giftware system according to claim 1, wherein the activation device comprises at least one of a tactile sensor and an accelerometer.

5. The interactive giftware system according to claim 4, wherein the tactile sensor comprises a push button switch

6. The interactive giftware system according to claim 4, wherein the tactile sensor comprises a proximity switch.

7. The interactive giftware system according to claim 1, wherein the activation device comprise a quick response (QR) code.

8. The interactive giftware system according to claim 1, wherein the notifier comprises an NFC device and a Bluetooth component.

9. The interactive giftware system according to claim 1, wherein the notifier comprises an NFC device and a Bluetooth component and the giftware item includes a QR code.

10. The interactive giftware system according to claim 1, wherein the notifier comprises at least one of: at least one light emitting diode (LED); a sound transducer; and a vibration device.

11. The interactive giftware system according to claim 1, wherein the giftware item comprises at least one of: jewelry with at least one of precious, semiprecious, synthetic and/or resin stones; jewelry without stones; clothing items; stuffed toys; and drinking vessels.

12. The interactive giftware system according to claim 1, wherein the smart device comprise at least one of a smart phone, tablet or phablet.

13. The interactive giftware system according to claim 1, wherein the giftware item comprises a unique identifier designating a location in the server for the content uploaded for the giftware item.

14. An interactive giftware item comprising:
a notifier having at least one of:
an NFC device; and
a Bluetooth module and at least one of a tactile sensor and an accelerometer;
at least one of: at least one light emitting diode (LED); a sound transducer; and a vibration device; and
a controller structured and arranged to control the notifier.

15. The interactive giftware item according to claim 14, wherein the giftware item comprises at least one of: jewelry with at least one of precious, semiprecious, synthetic and/or resin stones; jewelry without stones; clothing items; stuffed toys; and drinking vessels.

16. The interactive giftware item according to claim 14, wherein the tactile sensor comprises at least one of a push button switch and a proximity switch.

17. The interactive giftware item according to claim 14, further comprising a QR code at least one of affixed to and imbedded on the giftware time.

18. A method for retrieving content stored on a server, the method comprising:
receiving a notification from a giftware item of new content uploaded to a server; and
activating the giftware item, which instructs a smart device to retrieve and play the content.

19. The method according to claim 18, wherein the smart device comprises a notification application to communicate with the server and the giftware item.

20. The method according to claim 18, wherein the smart device retrieves and plays content stored in a location in the server designated by a unique identifier of the giftware item.
